(19) United States
(12) Patent Application Publication
(10) Pub. No.: US 2003/0196210 A1
(43) Pub. Date: Oct. 16, 2003

(54) Method and apparatus for simultaneously transmitting video, sound, data and ordinary telephone service, bidirectionally over an ordinary twisted pair

(76) Inventor: John P. Alves, Vacaville, CA (US)

Correspondence Address: Sheldon R. Meyer, FLIESLER DUBB MEYER & LOVEJOY LLP, Four Embarcadero Center, Fourth Floor, San Francisco, CA, 94111-4156, US

(21) Appl. No.: 10/372,462

(22) Filed: Feb. 21, 2003

Related U.S. Application Data
(60) Provisional application No. 60/359,168, filed on Feb. 22, 2002.
(60) Provisional application No. 60/449,071, filed on Feb. 20, 2003.

(51) Int. Cl. H04N 7/173; H04B 1/56; H04L 5/14; H04Q 7/20

(52) U.S. Cl. 725/126; 370/276; 455/454

(57) ABSTRACT

An apparatus and method for modulating and simultaneously bi-directionally transmitting full-motion, television-quality color video signals and associated audio and data signals, together with a digital subscriber line (DSL) and plain old telephone service (POTS) over a single ordinary twisted copper pair telephone (TCP) wire. Video signals are transmitted using vestigial sideband transmission such that each video signal occupies approximately 6 MHz of bandwidth on the TCP wire. DSL data signals and POTS signals are transmitted on the TCP wire at non-interfering frequencies as are the audio and data channels associated with the video signals.

### CROSS-REFERENCE TO RELATED APPLICATIONS

This application claims the benefit of U.S. Provisional Application No. 60/359,168, Method And Apparatus For Simultaneously Transmitting Video, Sound, Data And Ordinary Telephone Service, Bidirectionally Over an Ordinary Twisted Pair, by John P. Alves, filed Feb. 22, 2002, incorporated herein by reference; and U.S. Provisional Application No. ______, Method And Apparatus For Simultaneously Transmitting Video, Sound, Data And Ordinary Telephone Service, Bidirectionally Over an Ordinary Twisted Pair, by John P. Alves, filed Feb. 20, 2003, incorporated herein by reference.

### FIELD OF INVENTION

The present invention relates to transmission of multiple signals over an ordinary twisted copper pair (TCP). More particularly, the invention relates to simultaneously transmitting full-duplex television-quality color video signals, associated stereo sound and digital processing data (VVD), together with high-speed digital subscriber line (DSL) signals and plain old telephone service (POTS) over an ordinary twisted copper pair.

### BACKGROUND

The goal of industry is to provide consumers with bi-directional streaming video with sound and high-speed data in a DSL signal alone with POTS over the existing single copper pair wire connection. The telephone industry has spent significant amounts of money upgrading the infrastructure of the telecommunications backbone. However, streaming video is still not in wide use or standardization over the DSL connection using the existing TCP.

TCP wiring can be used to transmit voice grade signals in accordance with well known schemes and is well adapted for such transmissions. Such wiring can also been used to transmit low-speed data signal, such as those generated by modem. The baseband signal of such voice and low-speed data communications has an upper limit of approximately 20 kHz.

More recently, TCP wiring has been used to transmit DSL signals simultaneously with voice signals over a common TCP wire. The transmission of such DSL signals is well known in the art and are described in an article entitled “ADSL: A New Twisted Pair Access to the Information Highway,” Kyees et al., IEEE Communications Magazine, Apr. 1995, pages 52-59 and numerous other articles. Accordingly, DSL services typically operate in the between 4 kHz and 1100 kHz. This bandwidth is typically divided to allow approximately 1.1 to 6 mb/s downstream data flow and 64 to 384 kb/s upstream data flow. The overlay of DSL and POTS permits a user to simultaneously send and receive high-speed data communications and use POTS over a single TCP wire. A delivery method for streaming video with television quality is continually being worked on by service providers, hardware and software vendors. However the industry continues without a widely accepted standard or solution for delivery of such services.

Cable and satellite providers are the only source for quality streaming television, delivering such signals as NTSC. The signal interface with end user devices such as television sets and computers equipped with video overlay cards.

A typical baseband composite NTSC video signal occupies approximately 4.2 MHz of bandwidth, including luminance signal, color subcarrier, and color signals comprising chrominance information. A sound carrier signal also may be provided with the video signal to transmit audio information. In addition to the baseband and sound carrier signals, the typical NTSC signal comprises various other synchronizing signals needed to reconstruct the original signal at the receiver. Details of the signal structure are set forth in standards promulgated by the Federal Communication Commission under section 73.699 of title 47 of the Code of Federal Regulation, incorporated herein by reference.

When a baseband NTSC signal is used to amplitude modulate a carrier signal, the bandwidth is typically doubled, to approximately 8.4 MHz. The process of amplitude modulation using the baseband video signal produces a signal having an upper picture sideband and a lower picture sideband centered around the picture carrier. Both sidebands in any signal contain all the necessary intelligence to recreate the original information.

Commercial television transmitting stations use vestigial sideband AM transmission. The transmitting equipment suppresses the lower picture sideband in order to reduce the required bandwidth (vestigial sideband modulation). The lower sideband is mostly removed, leaving only a vestige in addition to the upper sideband. This allows commercial TV to be transmitted with a 6 MHz channel spacing, including audio carriers and guard bands. Thus, many TV stations can simultaneously broadcast without interfering with each other.

Due to bandwidth limitation associated with TCP wiring, it is necessary to limit the total transmission bandwidth to less than 20 MHz. Attempting to transmit an amplitude modulated video signal is not feasible over ordinary telephone wire due to severe transmission effects including distortions which cause unacceptable group delays. Although the use of frequency or phase modulation instead of amplitude modulation could mitigate some of these effects, the bandwidth required would be prohibitive.

Even with narrow deviation FM, a frequency modulated carrier produces a signal spectrum that is a least twice the baseband frequency. For video signals, that would require a minimum of 10 MHz per channel. For full-duplex operation (i.e., simultaneously transmitting video signals in both directions over the same wire), two 10 MHz channels would be needed, which would consume all of the available bandwidth on the TCP wiring.

To overcome the aforementioned limitations, vestigial sideband FM signals may be used. This means that one of the FM modulation sidebands is removed at the transmitter, preferably the upper sideband for reasons that will become apparent. By using this type of modulation, the original NTSC baseband signal can be reconstructed using only 6 MHz of bandwidth while allowing for a few megahertz of interchannel guard band. The 6 MHz band can include a broadcast quality video signal and the accompanying audio signal, although in various embodiments the audio signal is filtered out along with the upper sideband. One or more CD-quality audio signals may also be transmitted using a separate data channel. One example of this type of vestigial sideband FM signal modulation is described in U.S. Pat. No. 5,621,455 issued to Rodgers et al. This technology has been used in connection with POTS, but not with high-speed data communication services such as DSL.

Therefore, what is needed is a method and apparatus that can simultaneously transmit and receive video with associated audio and data signals, together with a high-speed DSL signal, and POTS over TCP wiring.

### SUMMARY

The present invention provides a method and apparatus for inexpensively transmitting full-motion, television-quality color video signals and associated audio signals, together with duplex DSL signals and POTS over a single TCP wire. The invention is characterized by a transmission method which allows two NTSC composite signals, containing video associated data and audio, to be simultaneously transmitted bidirectionally over a single TCP along with DSL and POTS without interference on the same pair of wires.

The POTS service is operates within the bandwidth of 0-4 kHz, the DSL service operates within the bandwidth from 4-1100 kHz and the video signals and associated audio and data signals operate within the bandwidth from 1.1 MHz to 20 MHz. Thus, all three services (video with associated audio and data, DSL and POTS) can operate over a single TCP wire.

Other features and advantages of the invention will become apparent through the following detailed description and drawings.

### BRIEF DESCRIPTION OF THE DRAWINGS

The present invention is described with respect to particular exemplary embodiments thereof and reference is accordingly made to the drawings in which:

FIG. 1 is a block diagram of one embodiment showing interconnection of services.

FIG. 2 is a block diagram of a secure internet network used for simultaneously transmitting a plurality of signals.

FIG. 3 is a frequency spectrum plot showing transmission frequencies bandwidths used in one embodiment.

FIG. 4 is a block diagram showing one embodiment of network element connectivity from a user location to a VVD modem.

FIG. 5 is a block diagram showing one embodiment of the network connectivity of a user location to the PSTN and the data transport path.

### DETAILED DESCRIPTION

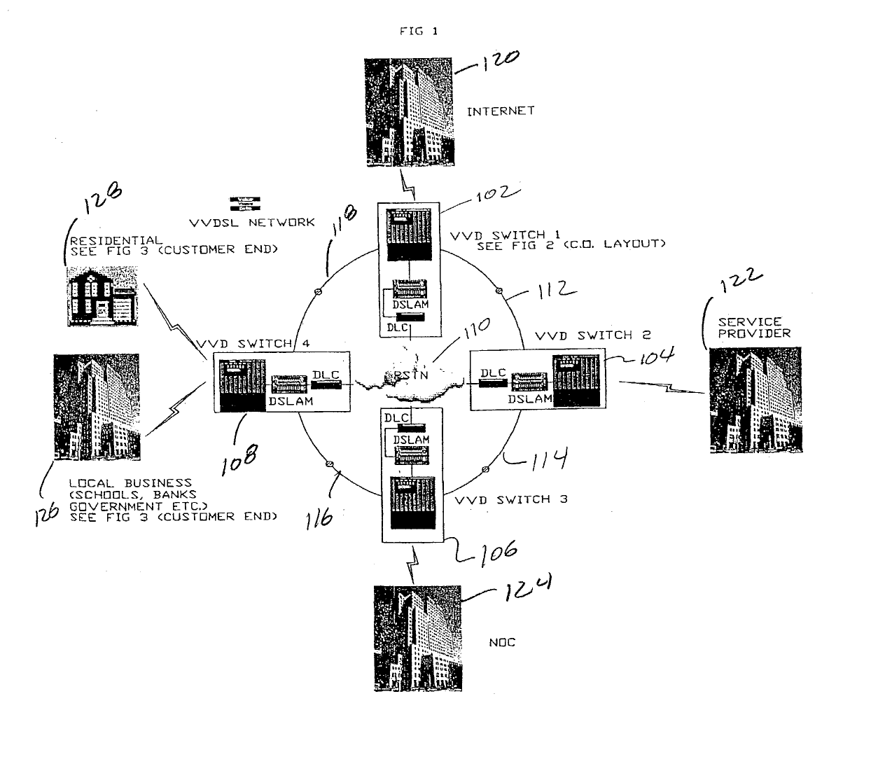

FIG. 1 is a block diagram of one embodiment showing the interconnections of VSD, DSL and POTS services from the Central Office (CO) to a user together with various network elements.

FIG. 1 shows multiple distribution sites 102, 104, 106, 108 connected via both a publicly switched telephone network (PSTN) 110 and network cables 112, 114, 116, 118. Each site containing a VVD Switch, DSLAM and DLC 102, 104, 106, 108 is capable of multiplexing and simultaneously transmitting and receiving VSD, DSL and POTS signals.

In the embodiment shown in FIG. 1, each location interfaces with at least one end user or service. In the embodiment shown in FIG. 1, one site 102 is associated with the Internet 120, a second site 104 serves an service provider 122, a third site 106 serves a Network Operations Center (NOC) 124 and the fourth site 108 serves local businesses 126 and residences 128. In alternate embodiments, multiple end users or services may be associated within each location and multiple locations may be linked to the PSTN or similar network they are also directly connected to each other via fiber optic transport.

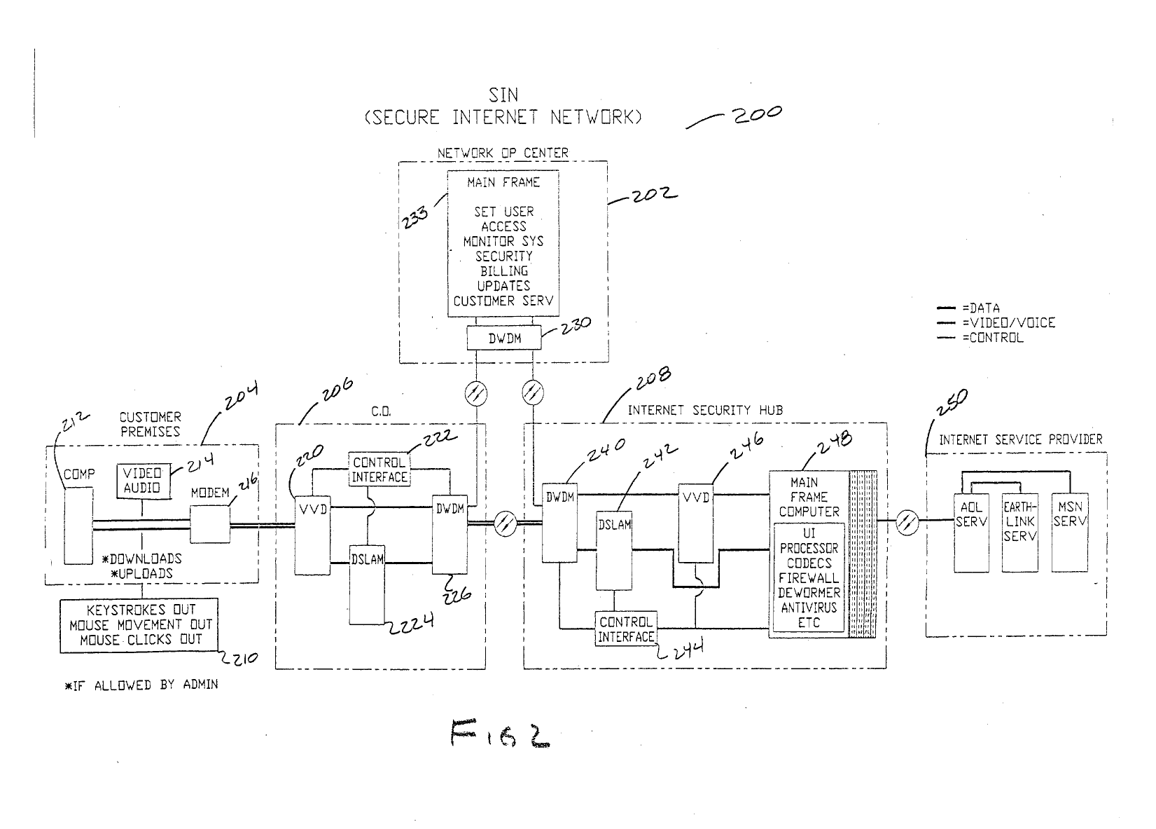

FIG. 2 is a block diagram of a secure internet network 200 used for simultaneously transmitting VSD, DSL and POTS signals. The secure internet network is comprised of a network operations center 202, a workstation 204, a central office (CO) 206 and an internet security hub (ISH) 208.

In the embodiment shown in FIG. 2, the workstation 204 includes user input devices 210, a computer 212, video and audio inputs and outputs 214 and a modem 216. The computer 212 is connected to the modem devices 216, the video and audio inputs and outputs 214 are also terminated to the modem 216.

In the embodiment shown in FIG. 2, the CO 206 includes a VVD switch 220, a control interface 222, a digital subscriber line access multiplexer (DSLAM) 224 and a dense wavelength division multiplexer (DWDM) 226. The control interface 222 is connected with the VVD switch 220, the DSLAM 224 and the DWDM 226 to direct signal flow to and from the devices. In the embodiment shown in FIG. 2, the VVD switch 220 is connected to the DWDM 226 both directly and indirectly via the DSLAM 226. In the configuration depicted in FIG. 2, voice and video signals travel directly between the VVD switch 220 and the DWDM 226 and DSL signals travel between the modem 216 through the VVD Switch and the DWDM 226 via the DSLAM 224.

In the embodiment shown in FIG. 2, the network operation center 202 is comprised of a DWDM 230 and a central computer or mainframe (Mainframe) 232. The DWDM 230 is connected to the Mainframe 232 and connected with both the CO 206 and the ISH 208 such that control signals can be bidirectionally transmitted between the network operation center 202 and the CO 206 or ISH 208.

In the embodiment shown if FIG. 2, the ISH 208 is comprised of a DWDM 240, a DSLAM 242, a control interface 244, a VVD switch 246 and a mainframe computer 248. The control interface 244 is connected to the DWDM 240, DSLAM 242, VVD switch 246 and the mainframe computer 248 to direct signal flow to and from the devices. In the embodiment shown in FIG. 2, the DWDM 240 is connected to the VVD switch 246 and the DSLAM 242. Furthermore, the VVD switch 248 and the DSLAM 242 are each connected to the mainframe computer 248. Voice and video signals travel between the DWDM 240 and the mainframe computer 248 via the VVD switch 246, while DSL signals travel between the DWDM 240 and the mainframe computer 248 via the DSLAM 242.

In the embodiment shown in FIG. 2, the mainframe computer 248 is primarily responsible for security of data within the secure internet network. The mainframe computer can employ any known technique, hardware or software implementation, such as codecs, firewall technologies, deworming technologies, anti-virus programs, and the like, to preserve the content of the signals within the secure internet network and restrict access to the secure internet network.

The ISH 208 is connected with an internet service provider (ISP) 250 such that data may be exchanged with systems outside the secure internet network 200.

In operation, a user's computer 212 is connected with the VVD switch 220 with two interfaces. The first interface is via the computer's video overlay card (not shown) which is used for encoding/decoding the computer monitors RGU and the VVD's composite NTSC and associated audio and data signals. The second interface is via the computer's network interface card (not shown) which is used for a data interface to the DSL signals. At the VVD switch 220, VVD signals are multiplexed in a non-interfering manner and transmitted to the CO 206 over a ordinary twisted copper pair (TCP). At the CO 206, video and voice signals are de-multiplexed and transmitted to the DWDM 226. The data signal is passed through the DSLAM 224 and transmitted to the DWDM 226. The DWDM 226 multiplexes the signals in a non-interfering manner and transmits the multiplexed signal to the ISH 208.

The DWDM 240 of the ISH 208 de-multiplexes the multiplexed signal into a voice and video signal and a data signal. The voice and video signal is transmitted to the VVD switch 246 and the data signal is transmitted to the DSLAM 242. The VVD switch 246 is connected to the mainframe computer 248 which processes the voice and video signal for transmission over the Internet. The DSLAM 242 is also connected to the mainframe computer 248 which processes the data signal for transmission over the Internet.

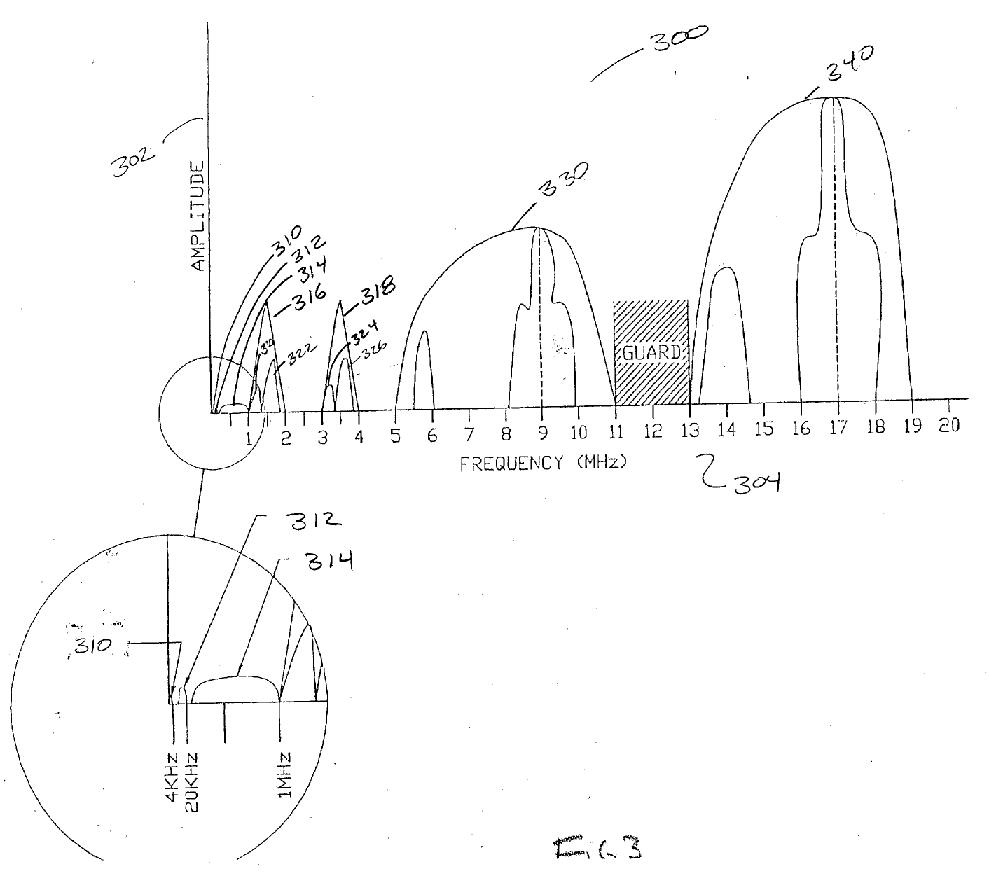

FIG. 3 is one embodiment of a frequency plan 300 which allows several signals to be simultaneously transmitted within the bandwidth available on a TCP wire. In FIG. 3, amplitude is represented on the vertical axis 302 and frequency in megahertz is represented on the horizontal axis 304. A number of signals are allocated in the frequency band ending at approximately 20 MHz.

A first signal 310 represents existing telephone signals at the very low end of the spectrum. These signals may be analog or digital. In either case, their spectrum components are typically below 4 kHz. However, in alternate embodiments various other frequency ranges may be used.

Signal 312 represents a first communication signal. In FIG. 3, the first communication signal 312 is shown as operating between approximately 4 kHz and approximately 20 kHz. Generally, the first communication signal is used to transmit data upstream. However, in alternate embodiments the first communication signal may be used to transmit data downstream or for another purpose.

Signal 314 represents a second communication signal. In FIG. 3, the second communication signal 314 is shown as operating between approximately 20 kHz and approximately 1 MHz. Generally, the second communication signal is used to transmit data downstream. However, in alternate embodiments the first communication signal may be used to transmit data downstream or for another purpose. Furthermore, in alternate embodiments, the first communication signal 312 and the second communication signal 314 may operate over different bandwidths than those described above. The bandwidths allocated to the first and second communication signals 312, 314 may be established according to specific needs. However, in the embodiment shown in FIG. 3, the first and second communication signal bandwidths are established in accordance with DSL standards.

Data signals 316 and 318 maybe centered about 1.5 MHz and 3.5 MHz, respectively, and may be used to transmit high-speed data bidirectionally across the wire using any of various well known modulation methods (including PSK, QAM, or FSK modulations). Data signals 316 and 318 each comprise a frequency modulated signal 320 and 324 for transmitting frequency modulated audio data which may correspond to video signals 330 and 340.

Digital data signals 322 and 326 represent digitally modulated data streams which may also accompany video signals 330 and 340. Thus, each data signal 316 and 318 may comprise various types of signal modulations which may be used to transmit information which can be related to corresponding video signals 330 and 340. The exact frequency placement of data signals 316 and 318 may be varied, consistent with telephone signal 310, video signals 330 and 340 and communication signals 312 and 314.

In the embodiment shown in FIG. 3, the carrier for video transmitter signal 330 is shown centered about approximately 9 MHz and the carrier for video transmitter signal 340 is illustrated as being centered about approximately 17 MHz. The lower sideband of signal 330 is shown between approximately 5.5 MHz and 6.1 MHz and the lower sideband of signal 340 is shown between approximately 13.3 MHz and approximately 14.7 MHz. The upper sidebands containing the color subcarrier signals have been suppressed according to known methods and are not shown. The sound carriers, located above the upper color sidebands, have also been suppressed and are not shown.

In accordance with the frequency plan of FIG. 3, two video signals may be simultaneously transmitted across a single TCP wire, each having an approximate bandwidth of 6 MHz. It should be noted that the illustrated center frequencies of the video and data signals are exemplary only, and it is of possible to move these signals around within the approximately 20 MHz of usable bandwidth or even above the 20 MHz if a user is willing to accept lower quality picture signals. Moreover, it is possible to use bandwidths of less than 6 MHz for each video signal, with readily recognizable tradeoffs in picture quality and the like.

Good picture quality over ordinary telephone wire can be obtained by using an NTSC video signal to frequency modulate a carrier signal and transmitting only the carrier, close-in sidebands, and one outlying sideband containing the color subcarrier at 3.58 MHz, preferably the lower sideband. In one embodiment, the carrier signal is centered at 10 MHz approximately, close-in sidebands fall in the range of 9 to 11 MHz, and the outlying lower sideband falls at 6.42 MHz (i.e., 10 MHz-3.58 MHz).

A SAW filter having a 3 dB bandwidth of 6 MHz can be used to appropriately filter the signal. This passband frequency translates to fall between about 5 and 11 MHz. The lower sideband centered on 6.42 MHz has its own “subsidebands” which imitate in shape the close-in sidebands around 10 MHz. To maintain good picture quality, these sub-sidebands can be transmitted on the carrier signal with reasonable fidelity. In one embodiment, the filter passband is adjusted down to 5 MHz (i.e., about 1.6 MHz below 6.42 MHz) to allow transmission of this signal.

Considering the simple phase modulation of a carrier with a low modulation index, the effect of suppressing one sideband is to convert the purely phase-modulated carrier into one which is simultaneously amplitude and phase modulated. If this signal is then passed through a limiter at the receiving end to suppress the amplitude modulation, a pure phase modulation is restored, but with a halving of the modulation index.

By placing the carrier near the upper end of the pass band, so that the transmitted sideband is the lower one, the effect of increasing attenuation with frequency in the twisted-pair cable is to boost the lower sideband relative to the carrier. This is in the optimum direction to compensate for the reduction in modulation index due to suppression of the upper sideband. Because the sound carrier in each NTSC signal is located in the portion of spectrum which is “cut off” by transmitting only the lower sideband, the audio signal may instead be modulated onto an FM carrier and transmitted as 316 or 318, for example (see FIG. 3).

In duplex operation over TCP wiring, filtering is required to separate the transmitted signal from the much weaker received signal, and some allowance must be made for the guard or transition bands of the filters used. Even in the case of a SAW filter, the transition band may be about 1 MHz wide. In various embodiments, a guard band width of 2 MHz has been assumed. However, in alternate embodiments a different guard band size may be used with varying impact on signal quality.

Based on the above considerations, a frequency plan such as that illustrated in FIG. 3 is described, but it is not intended to limit in any way the principles of the invention. As one example, a proximal transceiver may be located at the central telephone switch point, and a distal transceiver at a user's terminal such as in an office. The proximal transmitter carrier frequency may be 17 MHz, with nominal band limits of 13 to 19 MHz (signal 340 in FIG. 3). The distal transmitter carrier may be 9 MHz, with band limits of 5 to 11 MHz (signal 330 in FIG. 3). Thus, the guard band is from 11 to 13 MHz. It is a simple matter to make minor adjustments in these carrier frequencies to optimize performance in any particular application.

The predicted loss of 2000 ft of TCP level 3 will be about 76 dB at 17 MHz, but only about 56 dB at 9 MHz, or 20 dB less. Since there is a need for some minimum carrier-to-noise ratio at the receiver, it is desirable to transmit with more power at 17 MHz than at 9 MHz.

Still another consideration is that second harmonic distortion of the 9 MHz carrier, at 18 MHz, will have to be strongly suppressed at the distal station in order to avoid interference with the weak received carrier at 17 MHz. Thus the 9 MHz carrier can be relatively weaker. In the case of the 17 MHz transmitter, harmonic components at 34 MHz and above will be well removed from the receiver passband.

Assuming a noise figure of 10 dB in the receiver, together with a noise bandwidth of 6 MHz, a received signal strength at the distal station of −59 dBm should yield a video signal-to-noise ratio of about 37 dB, which is adequate for most purposes.

Although FIG. 3 describes specific frequency bandwidths for transmission and reception of specific signals, alternate frequency bandwidth allocations can be used with varying impact on signal quality.

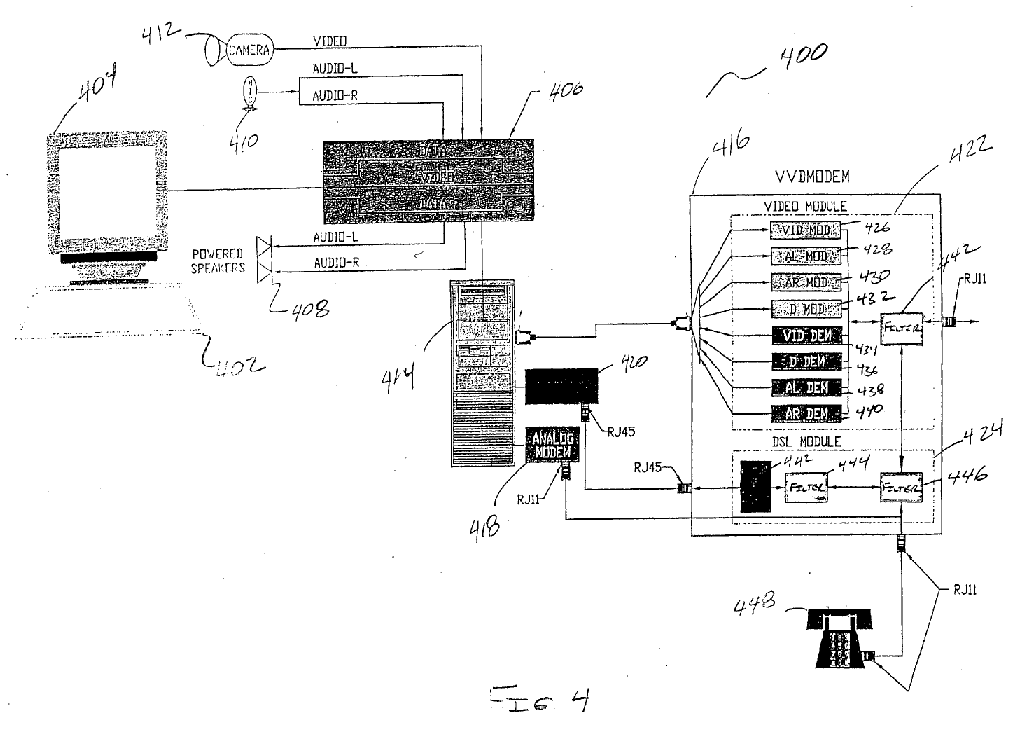

FIG. 4 is one embodiment of a user location 400. The user location includes at least one user input device 402 which may be a keyboard, mouse, or other device, a display 404. In the embodiment shown in FIG. 4, the display is connected to a video overlay card 406. The video overlay card 406 is designed to correctly direct and process signals for output to the display 404 and other devices. The user location depicted in FIG. 4 also includes stereo speakers 408 to output an audio signal received from the video overlay card, a stereo microphone 410 to receive audio signals and transmit them to the video overlay card and a camera 412 designed to capture TV-quality video images and transmit them to the video overlay card 406.

In the embodiment shown in FIG. 4, the video overlay card 406 is part of a computer 414 adapted to receive and transmit full-duplex high-speed data signals, full-duplex TV-quality video signals and analog modem signals.

In the embodiment shown in FIG. 4, the computer is connected to a VVD modem 416, an analog modem 418 and network interface card 420. The network interface card 420 is designed to transmit and receive high-speed data signals to and from the computer 414. However, in alternate embodiments, alternate devices may be used to transmit and receive high-speed data signals to and from the computer 414.

The VVD modem 416 shown in FIG. 4 includes a video module 422 and a DSL module 424. The video module 422 includes a video signal modulator 426, right and left audio signal modulators 428, 430 and an associated data signal modulator 432. The modulators 426, 428, 430, 432 modulate a video signal and associated audio signals, received from the computer in accordance with known means and in accordance with the frequency spectrum shown in FIG. 3 for transmission over TCP wiring.

The video module 422 shown in FIG. 4 also includes a video demodulator 434, a data signal demodulator 436, and right and left audio channel demodulators 438, 440. The demodulators 434, 436, 438, 440 demodulate received video signal and associated audio signals for transmission to the computer 414 and ultimately delivery to the display 404 and the speakers 408 for presentation to a user.

In the embodiment shown in FIG. 4, the video module also includes a filter 442. The filter 442 is designed to restrict transmission to and from the modulators 426, 428,430,432 and demodulators 434,436,438,440 in accordance with the prescribed video transmission/reception frequency bandwidths.

The DSL module 424 of the VVD modem 416 includes a DSL modem 442, a first filter 444 and a second filter 446. The first filter 444 is acts as a bandpass filter for signals received from the DSL modem 442 and an all pass filter for signals transmitted to the DSL modem 442. The bandpass portion of the filter 444 is designed to filter signals emanating from the DSL modem 442 such that only signals having frequencies within a predetermined frequency bandwidth are transmitted to the second filter 446. The second filter 446 is designed to filter signals such that only signals with a predetermined frequency bandwidth of POTS are transmitted to a telephone 448 or to the analog modem 418. The video, voice and data signals are then combined and transmitted via a TCP wire (not shown).

In operation, an incoming VVD signal is received over a single TCP wire. The signal is filtered at the video module's filter 442. Video signals and associated audio and data signals (collectively video signals) are transmitted to the video, data and audio channel demodulators 434, 436, 438, 440 where the signal is demodulated. The video signals are then transmitted to the computer's video overlay card 406 where they are processed for output on the display 404 and the over the speakers 408.

The non-video signals filtered at the video module's filter 442 are transmitted to the second filter 446 of the DSL module 424. The second filter divides the received signal into an a voice signal and a DSL signal. The voice signal is transmitted to either an analog modem used for low-speed communication signals or a telephone for-voice communications. The DSL signal is passed through the second filter 444 to the DSL modem where the signal is demodulated before being transmitted to the network interface card 420.

Simultaneously, a video signal can be received by the camera 412 and associated audio signals can be received by the microphone 410 (collectively, video signals). These signals are transmitted to the video overlay card 406 in the computer 414 where they are processed according to prescribed characteristics. The video signals are then transmitted to the video module of the VVD Modem where the signals are modulated for transmission by the video modulator, right and left audio channel modulators 428, 430 and the data modulator 432. The modulated signals are then transmitted to the filter 442 which combines the video signals with received DSL signals and voice signals.

Furthermore, while video signals are being received and transmitted, the network interface card 420 can transmit signals to the DSL modem which modulates the signal for transmission in the prescribed data communication frequency band. The modulated signal is transmitted to the first filter 444 which attenuates signals outside the prescribed data communication frequency band. The communication signal is then transmitted to the second filter where it is combined with voice signals from the analog modem 418 or a telephone 448. The second filter attenuates signals outside the frequency bands assigned to the communication signal and the voice signal. The combined voice and DSL signal is then transmitted to the video module filter 442 where it is combined with the modulated video signal. The resultant combined signal is then transmitted along a TCP wire (not shown).

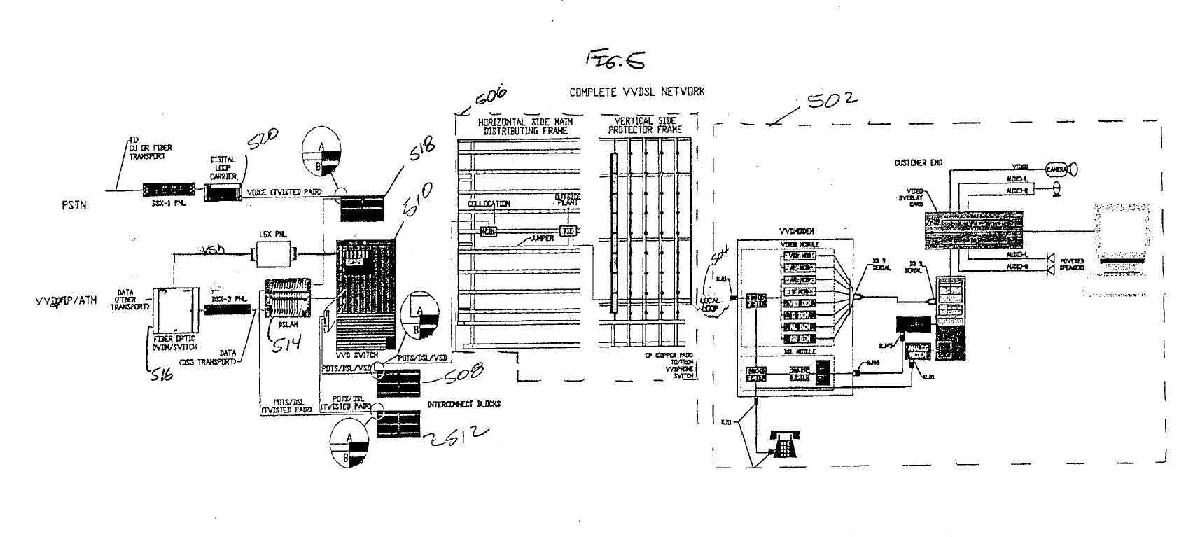

FIG. 5 is a block diagram showing one embodiment of the network connectivity of a user location to the PSTN and the data transport path.

In the embodiment shown in FIG. 5, a user location 502, as described above with reference to FIG. 4 receives and transmits signals via a the local loop 504. The local loop 504 is a TCP connecting the end user 502 to the central office mainframe 506. The Mainframe 506 is responsible for connection of signals to and from the local loop 504. In the embodiment shown in FIG. 5, the network control computer 506 is comprised of a horizontal side main distributing frame and a vertical side projector frame. However, other control and framing apparatuses may be used.

The Mainframe 506 is connecting to a first interconnect block which then terminates on interconnect block 508 which then terminates to the VVD, DSL and POTS signals to a VVD switch 510. The VVD switch 510 filters the video signals from the DSL and voice signals. The video signals are transmitted directly to a fiber optic DWDM switch where the video signals are transmitted with DSL signals to the Internet using know transportation protocols such as TCP/IP, ATM and the like, or to other VVD sites or network service sites.

The DSL and voice signals are transmitted to a second interconnect block 512 subsequently forwarded to a DSLAM 514. The DSLAM 514 filters the DSL signal from the received signal and transmits it to the DWDM switch 516. The DSL signal is then is transmitted with the VVD signal to the internet using known transportation protocols such as those described above, or to other VVD sites or network service sites.

The voice signal is transmitted from the DSLAM 514 to a third interconnect block 518 and in the embodiment shown in FIG. 5, subsequently transmitted to a digital loop carrier 520 for processing prior to transmission to the PSTN. In this manner, simultaneous transmission and reception of full-duplex voice, video and data signals is accomplished.

It should be understood that the particular embodiments described above are only illustrative of the principles of the present invention, and various modifications could be made by those skilled in the art without departing from the scope and spirit of the invention. Thus, the scope of the present invention is limited only by the claims that follow.

What is claimed is:

1. A method for simultaneously transmitting video information, an associate audio signal, a full-duplex data communication signal, a DSL signal and a telephonic audio signal over a single twisted copper pair wire, comprising the steps of:
frequency modulating a first carrier signal in accordance with a first composite video signal to produce a first FM signal comprising a first upper sideband and a first lower sideband;
filtering said first FM signal with a first band pass filter to suppress said first upper sideband and to pass said first lower sideband to produce a first filtered signal having a frequency bandwidth of approximately 6 MHz;
frequency modulating said first carrier signal in accordance with a first communications signal to create a first combined signal, such that said first filtered signal is not degraded by said first communications signal;
frequency modulating said first carrier signal in accordance with a first voice signal to create a first VVD signal, such that said first combined signal is not degraded by said first voice signal; and
injecting said first VVD signal into a TCP wire.

2. The method of claim 1, further comprising the steps of:
receiving said first VVD signal from said TCP wire;
filtering said received first VVD signal to isolate said received first filtered signal from other signals on said single pair of TCP wires; and
frequency demodulating said isolated first filtered signal such that it may be displayed on a display device.

3. The method of claim 2, further comprising the steps of:
frequency modulating a second carrier signal in accordance with a second composite video signal to produce a second FM signal comprising a second upper sideband and a second lower sideband;
filtering said second FM signal with a second band pass filter to suppress said second upper sideband and to pass said second lower sideband to produce a second filtered signal having a frequency bandwidth of approximately 6 MHz; and
frequency modulating said second carrier signal in accordance with a second communications signal to create a second combined signal, such that said second filtered signal is not degraded by either of said second communications signal and said first VVD signal;
frequency modulating said second carrier signal in accordance with a second voice signal to create a second VVD signal, such that said second combined signal is not degraded by either of said second voice signal and said first VVD signal; and
injecting said second VVD signal into a TCP wired.

4. The method of claim 3, further comprising the steps of:
receiving said second VVD signal from said TCP wire;
filtering said received second VVD signal to isolate said received second filtered signal from other signals on said single pair of TCP wires; and
frequency demodulating said isolated second filtered signal such that it may be displayed on a display device.

5. The method of claim 1, wherein said step of frequency modulating a first carrier signal comprises the step of using an NTSC video signal to frequency modulate said first carrier signal and producing said first FM signal with said color subcarrier located approximately 3.58 MHz above a center frequency of said first carrier signal.

6. The method of claim 1, wherein said step of frequency modulating a first carrier signal comprises the step of using a PAL format video signal to frequency modulate said first carrier signal.

7. The method of claim 1, wherein said step of frequency modulating a first carrier signal comprises the step of using a SECAM format video signal to frequency modulate said first carrier signal.

8. The method of claim 5, further comprising the step of convening an RGB computer screen display signal into said NTSC video signal.

9. The method of claim 5, wherein said step of frequency modulating a first carrier signal comprises the step of frequency modulating a carrier signal having a center frequency of approximately 9 MHz.

10. The method of claim 5, wherein said step of frequency modulating a first carrier signal comprises the step of frequency modulating a carrier signal having a center frequency of approximately 17 MHz.

11. The method of claim 1, wherein said first communications signal is a high-speed digital communications signal.

12. The method of claim 11, wherein said high-speed digital communications signal is a DSL signal.

13. The method of claim 11, wherein said first voice signal is a low-speed modulated data signal.

14. The method of claim 1, wherein said step of frequency modulating a first carrier signal is conducted without performing any pre-emphasis of said first composite video signal.

15. The method of claim 3, wherein said step of frequency modulating a second carrier signal comprises the step of using a carrier signal which has a center frequency at least 6 MHz higher than that of said first carrier signal, the method further comprising the step of amplifying said second filtered signal relative to said first filtered signal to accommodate signal attenuation at higher frequencies on said single pair of TCP wires.

16. The method of claim 15, wherein said step of frequency modulating a first carrier signal comprises the step of using a carrier signal having a center frequency of approximately 9 MHz, and wherein step of frequency modulating a second carrier signal comprises the step of using a carrier signal having a center frequency of approximately 17 MHz.

17. An apparatus for transmitting VVD signals over a single TCP wire comprising:
a first frequency modulating means for frequency modulating a first carrier signal in accordance with a first composite video signal to produce a first FM signal comprising a first upper sideband and a first lower sideband;
a first signal filtering means for filtering said first FM signal with a first band pass filter to suppress said first upper sideband and to pass said first lower sideband to produce a first filtered signal, said first signal filtering means being coupled with said first frequency modulating means;
a second frequency modulating means for frequency modulating said first carrier signal in accordance with a first communications signal to create a first combined signal, such that said first filtered signal is not degraded by said first communications signal, said second frequency modulating means being operatively associated with said first signal filtering means;
a third frequency modulating means for frequency modulating said first carrier signal in accordance with a first voice signal to create a first VVD signal, such that said first combined signal is not degraded by said first voice signal, said third frequency modulating means being operatively associated with said first signal filtering means; and
a transmitting means for transmitting said first VVD signal over a TCP wire.

18. The apparatus of claim 17, further comprising:
a first receiving means for receiving said first VVD signal from said TCP wire;
a fourth filtering means for filtering said received first VVD signal to isolate said received first filtered signal from other signals on said single pair of UTP wires; and
a first signal demodulation means for frequency demodulating said isolated first filtered signal such that it may be displayed on a display device.

19. The apparatus of claim 17, further comprising:
a fifth frequency modulation means for frequency modulating a second carrier signal in accordance with a second composite video signal to produce a second FM signal comprising a second upper sideband and a second lower sideband;
a sixth frequency modulating means for filtering said second FM signal with a second band pass filter to suppress said second upper sideband and to pass said second lower sideband to produce a second filtered signal having a frequency bandwidth of approximately 6 MHz; and
a seventh frequency modulating means for frequency modulating said second carrier signal in accordance with a second communications signal to create a second combined signal, such that said second filtered signal is not degraded by either of said second communications signal and said first VVD signal;
an eighth frequency modulating means for frequency modulating said second carrier signal in accordance with a second voice signal to create a second VVD signal, such that said second combined signal is not degraded by either of said second voice signal and said first VVD signal; and
a second signal transmission means for transmitting said second VVD signal via a TCP wired.

20. The method of claim 19, further comprising:
a second signal receiving means for receiving said second VVD signal from said TCP wire;
a fifth filtering means for filtering said received second VVD signal to isolate said received second filtered signal from other signals on said single pair of UTP wires; and
a second frequency demodulating means for frequency demodulating said isolated second filtered signal such that it may be displayed on a display device.
